(19) United States
(12) Patent Application Publication
(10) Pub. No.: US 2013/0305177 A1
(43) Pub. Date: Nov. 14, 2013

(54) METHOD FOR PROCESSING APPLICATION OBJECT AND ELECTRONIC DEVICE

(71) Applicant: Shuang Xia, Beijing (CN)

(72) Inventor: Shuang Xia, Beijing (CN)

(73) Assignee: Bejining Lenovo Software Ltd., Beijing (CN)

(21) Appl. No.: 13/981,293

(22) PCT Filed: Dec. 28, 2011
(86) PCT No.: PCT/CN2011/084834

§ 371 Date: Jul. 23, 2013

(30) Foreign Application Priority Data
Jan. 25, 2011 (CN) 201110027061.3

(51) Int. Cl. G06F 3/0484

(52) U.S. Cl. CPC G06F 3/0484
USPC 715/765

(57) ABSTRACT

The present invention provides a method for processing application object and an electronic device. The method for processing application object includes: obtaining a return instruction instructing to display an index interface on a display screen of an electronic device; obtaining a first determination result to determine whether a first application object exists, the first application object being currently in an opened state and associated with the index interface; and displaying the index to interface and a first indicator on the display screen when the first determination result indicates that the first application object exists, so as to prompt a user via the first indicator to perform a first predetermined operation in accordance with the first indicator so as to display the first application object on the display screen. With the embodiments of the present invention, the user can quickly find his/her target application object, such that the user's operation efficiency can be improved.

### TECHNICAL FIELD

The present invention relates to an electronic device, and more particularly, to a method for processing application object and an electronic device for the same.

### BACKGROUND

Currently, with continuous development of a processor technology, electronic devices become capable of executing more and more applications concurrently. When a user opens a plurality of objects at the same time, it becomes a problem that how to enable the user to quickly find an object he/she currently needs for operating from a number of opened objects, thereby improving the user's operation efficiency.

### SUMMARY

According to an embodiment of the present invention, a method for processing application object is provided. The method may includes steps of: obtaining a return instruction for instructing to display an index interface on a display screen of an electronic device; obtaining a first determination result to determine whether a first application object exists, the first application object being currently in an opened state and associated with the index interface; and displaying the index interface and a first indicator on the display screen when the first determination result indicates that the first application object exists, so as to prompt a user via the first indicator to perform a first predetermined operation in accordance with the first indicator so as to display the first application object on the display screen.

In a preferred embodiment, the method may further includes steps of: detecting a first operation performed by the user on the index interface; determining whether the first operation is the first predetermined operation to obtain a second determination result; and displaying the first application object on the display screen when the second determination result indicates that the first operation is the first predetermined operation.

In a preferred embodiment, one or more application objects associated with the index interface are preset and can be opened via the index interface. The step of obtaining the first determination result to determine whether the first application object exists may further includes: obtaining an application object currently in the opened state; and determining whether there is an application object among the preset one or more application objects that is the same as the application object currently in the opened state, so as to obtain the first determination result. The first determination result indicates that the first application exists when there is an application object among the preset one or more application objects that is the same as the application object currently in the opened state, or indicates that the first application does not exists otherwise.

In a preferred embodiment, an interface attribute is preset for the index interface. The step of obtaining the first determination result to determine whether the first application object exists may includes steps of: obtaining one or more application objects currently in the opened state; extracting an object attribute of each of the one or more application objects currently in the opened state; and determining whether there is an application object among the one or more application objects currently in the opened state whose object attribute matches the interface attribute, so as to obtain the first determination result. The first determination result indicates that the first application exists when there is an application object among the one or more application objects currently in the opened state whose object attribute matches the interface attribute, or indicates that the first application does not exists otherwise.

In a preferred embodiment, an interface attribute is preset for the index interface. The method further includes steps of: determining, when each application object is opened, whether an object attribute of the opened application object matches the interface attribute; and recording the opened application object in a set of application objects corresponding to the index interface when the object attribute of the opened application object matches the interface attribute. The step of obtaining the first determination result to determine whether the first application object exists may include steps of: determining whether there is an application object in the set of application objects corresponding to the index interface to obtain the first determination result. The first determination result indicates that the first application exists when there is an application object in the set of application objects corresponding to the index interface, or indicates that the first application does not exists otherwise.

In a preferred embodiment, when there is a plurality of first application objects, the step of displaying the first application object on the display screen may include steps of: displaying all of the plurality of first application objects on the display screen in a non-overlapping manner; or selecting one of the plurality of first application objects based on a predetermined rule for displaying on the display screen.

In a preferred embodiment, the method further includes steps of: after said selecting one of the plurality of first application objects based on the predetermined rule for displaying on the display screen, displaying a second indicator on the display screen, so as to prompt the user via the second indicator to perform a second predetermined operation in accordance with the second indicator so as to display another one of the plurality of first application objects on the display screen.

In a preferred embodiment, when there is a plurality of first application objects, the first indicator and the plurality of first application objects are displayed on the screen in a one-to-one correspondence.

In a preferred embodiment, the first indicator may include an operation directing line and the first operation is determined as the first predetermined operation when a track direction of the first operation follows a direction of the first operation directing line.

According to another embodiment of the present invention, an electronic device is provided. The electronic device may include: a display screen; an instruction obtaining module configured to obtain a return instruction instructing to display an index interface on the display screen; a first determining module configured to obtain a first determination result to determine whether a first application object exists, the first application object being currently in an opened state and associated with the index interface; and a first display processing module configured to display the index interface and a first indicator on the display screen when the first determination result indicates that the first application object exists, so as to prompt a user via the first indicator to perform a first predetermined operation in accordance with the first indicator so as to display the first application object on the display screen.

In a preferred embodiment, the electronic device further includes: a detecting module configured to detect a first operation performed by the user on the index interface; a second determining module configured to obtain a second determination result to determine whether the first operation is the first predetermined operation; and a second display processing module configured to display the first application object on the display screen when the second determination result indicates that the first operation is the first predetermined operation.

In a preferred embodiment, one or more application objects associated with the index interface are preset and can be opened via the index interface. The first determining module may include: a unit configured to obtain an application object currently in the opened state; and a unit configured to determine whether there is an application object among the preset one or more application objects that is the same as the application object currently in the opened state, so as to obtain the first determination result. The first determination result indicates that the first application exists when there is an application object among the preset one or more application objects that is the same as the application object currently in the opened state, or indicates that the first application does not exists otherwise.

In a preferred embodiment, an interface attribute is preset for the index interface. The first determining module may include: a unit configured to obtain one or more application objects currently in the opened state; a unit configured to extract an object attribute of each of the one or more application objects currently in the opened state; and a unit configured to determine whether there is an application object among the one or more application objects currently in the opened state whose object attribute matches the interface attribute, so as to obtain the first determination result. The first determination result indicates that the first application exists when there is an application object among the one or more application objects currently in the opened state whose object attribute matches the interface attribute, or indicates that the first application does not exists otherwise.

In a preferred embodiment, an interface attribute is preset for the index interface. The electronic device further includes: a attribute determining module configured to determine, when each application object is opened, whether an object attribute of the opened application object matches the interface attribute; and a recording module configured to record the opened application object in a set of application objects corresponding to the index interface when the object attribute of the opened application object matches the interface attribute. The first determining module includes: a unit configured to determine whether there is an application object in the set of application objects corresponding to the index interface to obtain the first determination result. The first determination result indicates that the first application exists when there is an application object in the set of application objects corresponding to the index interface, or indicates that the first application does not exists otherwise.

In a preferred embodiment, when there is a plurality of first application objects, the displaying module is configured to display all of the plurality of first application objects on the display screen in a non-overlapping manner or select one of the plurality of first application objects based on a predetermined rule for displaying on the display screen.

The embodiments of the present invention have the following advantageous effects. With the method for processing application object and the electronic device according to the embodiments of the present invention, an index interface is provided and an indicator is displayed on the index interface to indicate that the user can find the application object which is opened and associated with the index interface by operating in accordance with the indicator. In this way, the user can quickly find his/her target application object, such that the user's operation efficiency can be improved.

### BRIEF DESCRIPTION OF THE DRAWINGS

FIG. 1 is a flowchart illustrating the method for processing application object according to an embodiment of the present invention;

FIG. 2 is a schematic diagram showing a user interface including four index interfaces;

FIG. 2a and FIG. 2b are schematic diagrams showing a variation of the user interface according to an embodiment of the present invention;

FIG. 3 is a schematic diagram showing a display interface on a display screen where all of the first application objects are displayed simultaneously in a non-overlapping manner, according to an embodiment of the present invention; and

FIG. 4 is a schematic diagram showing an interface on which the first indicator and the first application objects are displayed in a one-to-one correspondence, according to an embodiment of the present invention.

### DETAILED DESCRIPTION OF THE EMBODIMENTS

With the method for processing application object and the electronic device according to the embodiments of the present invention, an index interface is provided and an indicator is displayed on the index interface to indicate that the user can find the application object which is opened and associated with the index interface by operating in accordance with the indicator. In this way, the user can quickly find his/her target application object, such that the user's operation efficiency can be improved.

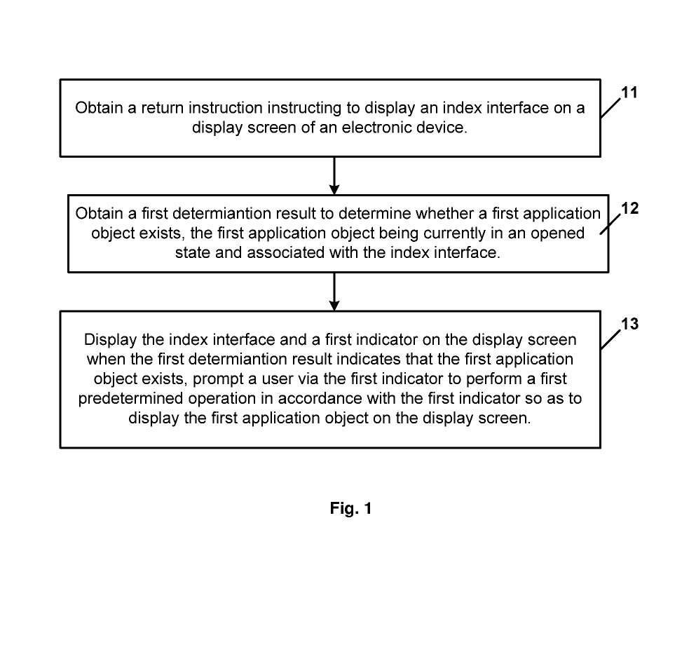

As shown in FIG. 1, a method for processing application object according to an embodiment of the present invention can be applied in an electronic device having a display screen. The method may include the following steps.

At step 11, a return instruction is obtained. The return instruction instructs to display an index interface on a display screen of an electronic device.

At step 12, a first determination result is obtained to determine whether a first application object exists. The first application object is currently in an opened state and associated with the index interface.

At step 13, the index interface and a first indicator are displayed on the display screen when the first determination result indicates that the first application object exists, so as to prompt a user via the first indicator to perform a first predetermined operation in accordance with the first indicator so as to display the first application object on the display screen.

With the above process, after returning to the index interface, the user can determine whether there is currently an application object that is opened and associated with the index interface based on whether the first indicator is displayed on the index interface. If there is no indicator, it is indicated that there is currently no application object that is opened and associated with the index interface. In this case, the user can open a corresponding application in any conventional manner.

On the other hand, if the indicator is displayed on the index interface, it is indicated that there is currently an application object that is opened and associated with the index interface. In this case, according to the prior art, there may be a number of application objects opened in the electronic device, given a high processor capability. At this time, on the home interface, the user needs to first enter the opened application objects and then search these opened application objects, one by one, using navigation keys or gestures until his/her target application object is found. When a large number of application objects are opened and the target application object is located in a latter part of the search sequence, the user needs to perform a large amount of operations, and the time is wasted.

With the method according to the embodiment of the present invention, an operation interface of an opened application object can be entered by performing a simple predetermined operation only. In an embodiment of the present invention, the method for processing application object may further include steps of: detecting a first operation performed by the user on the index interface; determining whether the first operation is the first predetermined operation to obtain a second determination result; and displaying the first application object on the display screen when the second determination result indicates that the first operation is the first predetermined operation.

In this case, the indicator is displayed on the index interface and it is indicated that there is currently an application object that is opened and associated with the index interface. Then, the user only needs to perform a predetermined operation (e.g., sliding in a predetermine direction on the index interface) and the electronic device will display the first application object on the display screen.

An example will be given below.

It is assumed that the user has opened an MSN application, a Media Player application, a WordPad application, an Outlook application, an Explorer application, a Card application, and so on, and the index interface is an interface corresponding to real time chat. In this case, when the user returns to the index interface from any one of the application interface, it is determined whether there is an opened chat-related application object (e.g., any of various instant chatting software applications such as MSN and QQ). Since the user has opened the MSN application, the determination result indicates “yes” and the electronic device will display the index interface on the display screen along with prompt information.

The user can learn the following two points from the prompt information: 1) a chat-related application object has been opened in the electronic device; and 2) the opened, chat-related application object can be displayed on the display screen by performing a predetermined operation.

Then, the user performs an operation (e.g., sliding in a predetermine direction on the index interface). The operation is captured at the electronic device and, when the operation is determined as the predetermined operation, the first application object will be directly displayed on the display screen. In contrast, according to the prior solution, the search needs to be performed step by step until the target application object is found. Therefore, with the embodiment of the present invention, the speed at which the user can find and open the target application object can be significantly increased.

It is assumed that the user has opened an MSN application, a Media Player application, an Outlook application, an Explorer application, and so on. At this time, if the user generates a return instruction by pressing a particular key on the interface of a particular application or manually performing a particular operation and if there are four index interfaces preset (including a multimedia play index interface, a chat index interface, a mail index interface and a game-related index interface, for example), the electronic device will make the following four determinations as to, respectively, whether there is an application object that is currently in an opened state and is associated with the multimedia play index interface, whether there is an application object that is currently in an opened state and is associated with the chat index interface, whether there is an application object that is currently in an opened state and is associated with the mail index interface, and whether there is an application object that is currently in an opened state and is associated with the game index interface.

At this time, since the Media Player application is opened, there is an application object that is associated with the multimedia play index interface.

Since the MSN application is opened, there is an application object that is associated with the chat index interface.

Since the Outlook application is opened, there is an application object that is associated with the mail index interface.

However, there is no application object that is in an opened state and is associated with the game index interface.

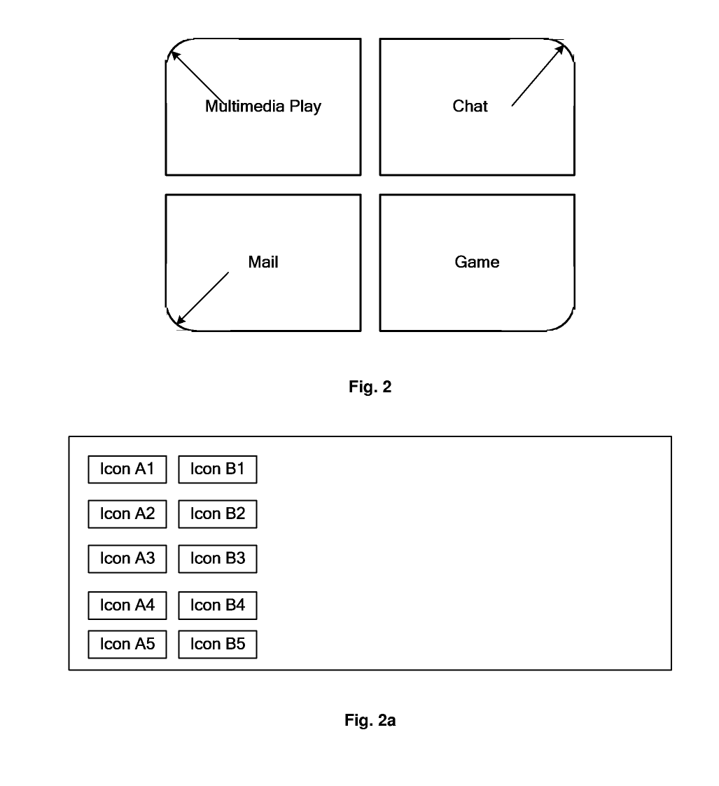

With the above determinations, a large user interface can be displayed on the display screen. As shown in FIG. 2, the user interface includes four index interfaces, which are a multimedia play index interface, a chat index interface, a mail index interface and a game-related index interface, respectively.

At the same time, a visible indicator is displayed on each of the multimedia play index interface, the chat index interface and the mail index interface.

In this case, from the indicator on the four index interfaces of the user interface, the user can directly learn that there are application objects that are opened and associated with the multimedia play index interface, the chat index interface and the mail index interface, respectively.

If the user needs to enter a mail application, he/she can enter the interface of the Outlook application by simply performing a predetermined application on the mail index interface. Of course, if the user needs to enter a chat application, he/she can enter the interface of the MSN application by simply performing a predetermined application on the chat index interface.

As shown in FIG. 2, a large interface consisting of the four index interfaces in FIG. 2 can be a predefined home operation interface in various electronic devices. In existing operating systems for electronic devices, the user can return to this home operation interface in various ways, such as by pressing a home key or a return key. The embodiment of the present invention differs from the conventional operation for returning to the interface in that it is further determined whether there is an application object in the opened state and associated with any of these index interfaces and that a visible indicator is provided for prompting the user if there is such application object.

Further, in a preferred embodiment, the large interface consisting of the four index interfaces in FIG. 2 can alternatively be a user interface which is temporarily generated based on the user's instruction. When the user generates a return instruction by pressing a particular key on the interface of a particular application or manually performing a particular operation, a return user interface can be provided (by means of temporary selection or pre-configuration based on a profile) such that it includes the multimedia play index interface, the chat index interface, the mail index interface and the game-related index interface. In this way, the above user interface shown in FIG. 2 can be obtained.

According to an embodiment of the present invention, the return instruction is executed to return to the home operation interface. However, in the prior art, there is no index interface on the home operation interface. Thus, according to the embodiment of the present invention, at this time, it is not only necessary to determine whether there is an application object that is in the opened state and is associated with any of the index interfaces, but also necessary to generate and display these index interfaces at some location (e.g., a blank location) on the home operation interface. In this way, a visible indicator can be provided for prompting the user.

FIG. 2a is a schematic diagram showing an original home operation interface including 20 icons. With the method according to the embodiment of the present invention, as shown in FIG. 2b, the four index interfaces are displayed at the blank on the original operation interface and visible indicators are provided on the four index interfaces in accordance with the opened state of the application objects.

According to the embodiment of the present invention, it is determined whether there is an application object that is in the opened state and is associated with an index interface. Regarding the determination as to whether an application object is “opened”, a process currently executed can be simply determined as “opened”. The determination as to whether an application is associated with an index interface can be made in various schemes according to the embodiments of the present invention, which will be explained below.

Scheme I

In this scheme, one or more application objects associated with the index interface are preset and can be opened via the index interface. Therefore, according this scheme, the process for determining whether there is a first application object that is in the opened state and associated with the index interface to obtain a first determination result may include steps of: obtaining an application object currently in the opened state; and determining whether there is an application object among the preset one or more application objects that is the same as the application object currently in the opened state, so as to obtain the first determination result. The first determination result indicates that the first application exists when there is an application object among the preset one or more application objects that is the same as the application object currently in the opened state, or indicates that the first application does not exists otherwise.

An example will be given below.

Returning to FIG. 2, the following application objects are provided, which are associated with the four index interfaces shown in FIG. 2, respectively:
Media Player, Storm Media, . . . , associated with the multimedia play index interface;
MSN, QQ, . . . , associated with the chat index interface;
Outlook, Foxmail, . . . , associated with the mail index interface; and
WOW, Starcraft, . . . , associated with the game-related index interface.

At this time, the user can directly open the associated applications, or application objects, on these interfaces.

When the user generates a return instruction by pressing a particular key on the interface of a particular application or manually performing a particular operation, the currently opened MSN, Media Player, Outlook and Explorer applications are compared with a preset management application object corresponding to each of the four index interfaces. If the comparison result indicates that a currently opened application object is the same as any preset management application object, it is then determined that there is a first application object that is in the opened stated and associated with an index interface. In this example, there are application objects that are opened and associated with the multimedia play index interface, the chat index interface and the mail index interface, respectively.

Scheme II

It can be appreciated that all the application objects can be opened in any of the existing ways. In this case, an interface attribute can be preset for the index interface. Therefore, in this scheme, the process for determining whether there is a first application object that is in the opened state and associated with the index interface to obtain a first determination result can include steps of: obtaining one or more application objects currently in the opened state; extracting an object attribute of each of the one or more application objects currently in the opened state; and determining whether there is an application object among the one or more application objects currently in the opened state whose object attribute matches the interface attribute, so as to obtain the first determination result. The first determination result indicates that the first application exists when there is an application object among the one or more application objects currently in the opened state whose object attribute matches the interface attribute, or indicates that the first application does not exists otherwise.

For the chat index interface as an example, its interface attribute can be configured as “chat”. Further, an object attribute can be preset, by the user or the system, for each application object installed in the electronic device. In this case, the extracted object attribute of each application object currently in the opened state can be directly compared with the interface attribute of the chat index interface. If there is an application object whose object attribute is the same as the interface attribute, it is then determined that there is an application object that is in the opened stated and associated with the chat index interface. If there is no application object whose object attribute is the same as the interface attribute, it is then determined that there is no application object that is in the opened stated and associated with the chat index interface.

It is to be noted that the rule for configuring the index interface is not necessarily limited to the above example. For an object attribute of “entertainment” as an example, its corresponding interface attribute can be configured as “gaming”, “novel reading”, “multimedia viewing” or the like. There is a generic-specific relationship between “entertainment” and “gaming”, “novel reading” or “multimedia viewing”. In this case, the extracted object attribute can be compared with the interface attribute of the chat index interface to check whether there is a generic-specific relationship between them. If so, it is determined that there is an application object that is in the opened stated and associated with the corresponding index interface; otherwise, it is determined that there is no application object that is in the opened stated and associated with the corresponding index interface.

Of course, the determination as to whether an object attribute matches an interface attribute can be made in any of the existing ways and the details thereof will be omitted here.

Scheme III

In this scheme, an interface attribute is preset for the index interface. According to the embodiment of the present invention, the method for processing application object further includes steps of: determining, when each application object is opened, whether an object attribute of the opened application object matches the interface attribute; and recording the opened application object in a set of application objects corresponding to the index interface when the object attribute of the opened application object matches the interface attribute.

The process for determining whether there is a first application object that is in the opened state and associated with the index interface to obtain a first determination result can include steps of: determining whether there is an application object in the set of application objects corresponding to the index interface to obtain the first determination result. The first determination result indicates that the first application exists when there is an application object in the set of application objects corresponding to the index interface, or indicates that the first application does not exists otherwise.

It is assumed that the user has opened the MSN, Media Player, Outlook and Explorer applications. In this case, a set of application objects is recorded in the system, as shown in the table below:

| | Opened Management Application |
|---|---|
| Index Interface | Object Set |
| Multimedia Play Index Interface | Media Player |
| Chat Index Interface | MSN |
| Mail Index Interface | Outlook |
| Game-related Index Interface | |

When the user generates a return instruction by pressing a particular key on the interface of a particular application or manually performing a particular operation, it is checked whether each of the opened management application object sets corresponding to the four index interfaces is empty or not. The first determination result indicates that the first application exists when there is an application object in the set of application objects corresponding to the index interface, or indicates that the first application does not exists otherwise.

Compared with Scheme I and Scheme II, Scheme III has a faster response speed since it does not need to extract and match the attribute information.

The present invention is not limited to the above embodiment in terms of the number of the index interfaces. It can be appreciated by those skilled in the art that there can be more or less index interfaces.

For example, in an embodiment of the present invention, there can be none, one or more first application objects. When there is a plurality of first application objects, the process of displaying the first application object on the display screen can include: displaying all of the plurality of first application objects on the display screen in a non-overlapping manner; or selecting one of the plurality of first application objects based on a predetermined rule for displaying on the display screen.

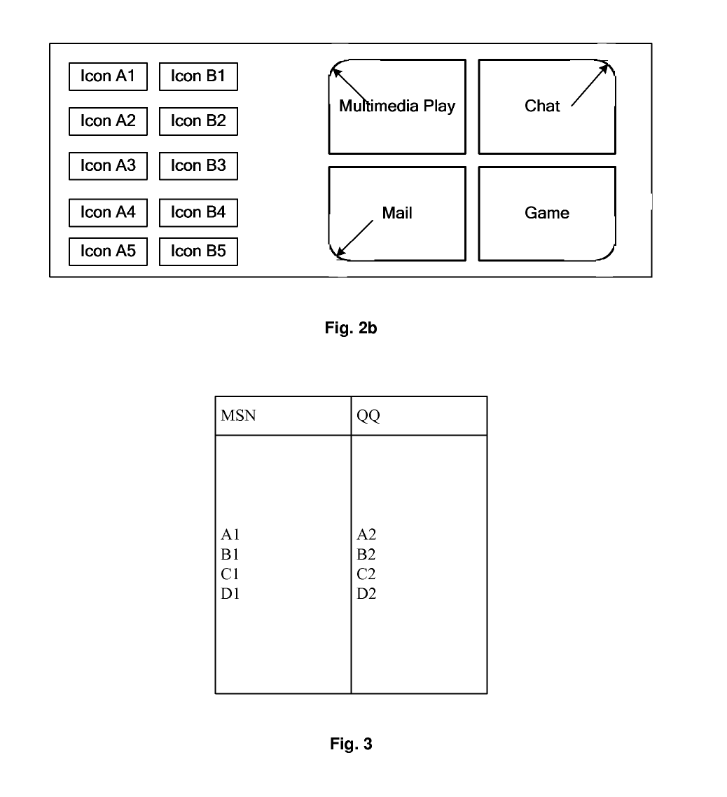

FIG. 3 shows a display interface on a display screen where all of the first application objects are displayed simultaneously in a non-overlapping manner. It is assumed here that the user has opened two chat-related applications: MSN and QQ. When the user performs a predetermined operation on the chat index interface shown in FIG. 2, the applications MSN and QQ will be displayed on the display screen in a non-overlapping manner.

Alternatively, one of the plurality of first application objects can be selected based on a predetermined rule (e.g., a rule that selects the application object which is most recently opened, the application object which has been executed for the highest number of times, or the application object most recently operated) for displaying on the display screen.

The method can further include: after selecting one of the plurality of first application objects based on the predetermined rule for displaying on the display screen: displaying a second indicator on the display screen, so as to prompt the user via the second indicator to perform a second predetermined operation in accordance with the second indicator so as to display another one of the plurality of first application objects on the display screen.

Further, according to an embodiment of the present invention, when there is a plurality of first application objects, there can be one or more first indicators to be displayed on the display screen. A plurality of first indicators and the plurality of first application objects can be configured and displayed in a one-to-one correspondence.

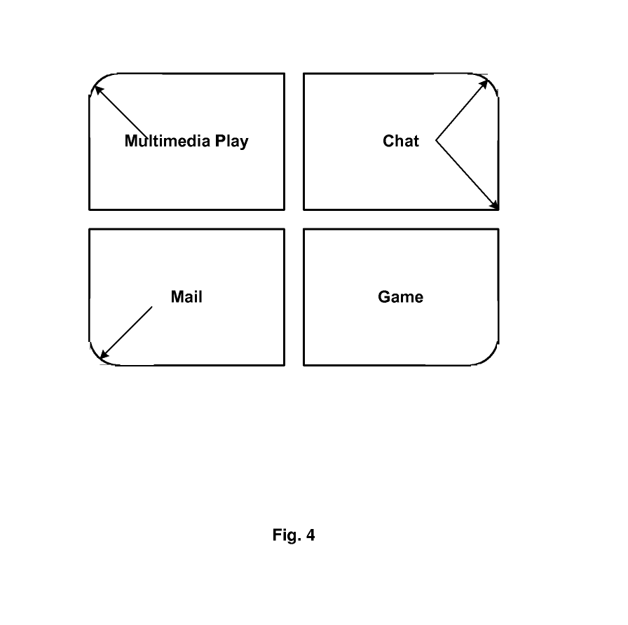

It is assumed here that the user has opened two chat-related applications: MSN and QQ. In this case, the chat index interface includes two indicators, as shown in FIG. 4.

In an embodiment of the present invention, the first indicator includes an operation directing line and the first operation is determined as the first predetermined operation when a track direction of the first operation follows a direction of the operation directing line.

An example will be given below for a touch screen with reference to FIG. 4. When a sliding operation to the lower right is performed on the chat index interface, a QQ interface will be entered; whereas when a sliding operation to the upper right is performed, an MSN interface will be entered.

When the directions of operation directing lines are different from each other, the above configuration works well. However, when all the operation directing lines have the same direction, they can be distinguished from each other based on the areas where their operation start points or operation end points are located.

The above indicator is exemplary only. The indicator can be represented by a button on the index interface.

According to another embodiment of the present invention, an electronic device is provided. The electronic device includes: a display screen; an instruction obtaining module configured to obtain a return instruction instructing to display an index interface on the display screen; a first determining module configured to obtain a first determination result to determine whether a first application object exists, the first application object being currently in an opened state and associated with the index interface; and a first display processing module configured to display the index interface and a first indicator on the display screen when the first determination result indicates that the first application object exists, so as to prompt a user via the first indicator to perform a first predetermined operation in accordance with the first indicator so as to display the first application object on the display screen.

In an embodiment of the present invention, the electronic device further includes: a detecting module configured to detect a first operation performed by the user on the index interface; a second determining module configured to obtain a second determination result to determine whether the first operation is the first predetermined operation; and a second display processing module configured to display the first application object on the display screen when the second determination result indicates that the first operation is the first predetermined operation.

In the electronic device according to an embodiment of the present invention, one or more application objects associated with the index interface are preset and can be opened via the index interface. The first determining module includes: a unit configured to obtain an application object currently in the opened state; and a unit configured to determine whether there is an application object among the preset one or more application objects that is the same as the application object currently in the opened state, so as to obtain the first determination result. The first determination result indicates that the first application exists when there is an application object among the preset one or more application objects that is the same as the application object currently in the opened state, or indicates that the first application does not exists otherwise.

In the electronic device according to an embodiment of the present invention, an interface attribute is preset for the index interface. The first determining module includes: a unit configured to obtain one or more application objects currently in the opened state; a unit configured to extract an object attribute of each of the one or more application objects currently in the opened state; and a unit configured to determine whether there is an application object among the one or more application objects currently in the opened state whose object attribute matches the interface attribute, so as to obtain the first determination result. The first determination result indicates that the first application exists when there is an application object among the one or more application objects currently in the opened state whose object attribute matches the interface attribute, or indicates that the first application does not exists otherwise.

In the electronic device according to an embodiment of the present invention, an interface attribute is preset for the index interface. The electronic device further includes: a attribute determining module configured to determine, when each application object is opened, whether an object attribute of the opened application object matches the interface attribute; and a recording module configured to record the opened application object in a set of application objects corresponding to the index interface when the object attribute of the opened application object matches the interface attribute. The first determining module may include: a unit configured to determine whether there is an application object in the set of application objects corresponding to the index interface to obtain the first determination result. The first determination result indicates that the first application exists when there is an application object in the set of application objects corresponding to the index interface, or indicates that the first application does not exists otherwise.

In the electronic device according to an embodiment of the present invention, when there is a plurality of first application objects, the displaying module is configured to display all of the plurality of first application objects on the display screen in a non-overlapping manner or select one of the plurality of first application objects based on a predetermined rule for displaying on the display screen.

According to an embodiment of the present invention, the electronic device can further display a second indicator on the display screen, so as to prompt the user via the second indicator to perform a second predetermined operation in accordance with the second indicator so as to display another one of the plurality of first application objects on the display screen.

When there is a plurality of first application objects, the first indicator and the plurality of first application objects are displayed on the screen in a one-to-one correspondence.

The first indicator can be an operation directing line and the first operation is determined as the first predetermined operation when a track direction of the first operation follows a direction of the operation directing line.

While the preferred embodiments of the present invention have been described above, it should be noted that various modifications and improvements can be made by those skilled in the art without departing from the principle of the present invention. These modifications and improvements are to be encompassed by the scope of the present invention.

1. A method for processing an application object, comprising steps of:
obtaining a return instruction instructing to display an index interface on a display screen of an electronic device;
obtaining a first determination result to determine whether a first application object exists, the first application object being currently in an opened state and associated with the index interface; and
displaying the index interface and a first indicator on the display screen when the first determination result indicates that the first application object exists, so as to prompt a user via the first indicator to perform a first predetermined operation in accordance with the first indicator so as to display the first application object on the display screen.

2. The method for processing application object of claim 1, further comprising steps of:
detecting a first operation performed by the user on the index interface;
determining whether the first operation is the first predetermined operation to obtain a second determination result; and
displaying the first application object on the display screen when the second determination result indicates that the first operation is the first predetermined operation.

3. The method for processing application object of claim 1, wherein one or more application objects associated with the index interface are preset and opened via the index interface, and said obtaining the first determination result to determine whether the first application object exists comprises steps of:
obtaining an application object currently in the opened state; and
determining whether there is an application object among the preset one or more application objects that is the same as the application object currently in the opened state, so as to obtain the first determination result,
wherein the first determination result indicates that the first application exists when there is an application object among the preset one or more application objects that is the same as the application object currently in the opened state, or indicates that the first application does not exists otherwise.

4. The method for processing application object of claim 2, wherein an interface attribute is preset for the index interface, and said obtaining the first determination result to determine whether the first application object exists comprises steps of:
obtaining one or more application objects currently in the opened state;
extracting an object attribute of each of the one or more application objects currently in the opened state; and
determining whether there is an application object among the one or more application objects currently in the opened state whose object attribute matches the interface attribute, so as to obtain the first determination result,
wherein the first determination result indicates that the first application exists when there is an application object among the one or more application objects currently in the opened state whose object attribute matches the interface attribute, or indicates that the first application does not exists otherwise.

5. The method for processing application object of claim 2, wherein an interface attribute is preset for the index interface and the method further comprises steps of:
determining, when each application object is opened, whether an object attribute of the opened application object matches the interface attribute; and
recording the opened application object in a set of application objects corresponding to the index interface when the object attribute of the opened application object matches the interface attribute, and
said obtaining the first determination result to determine whether the first application object exists comprises:
determining whether there is an application object in the set of application objects corresponding to the index interface to obtain the first determination result;
wherein the first determination result indicates that the first application exists when there is an application object in the set of application objects corresponding to the index interface, or indicates that the first application does not exists otherwise.

6. The method for processing application object of claim 3, wherein said displaying the first application object on the display screen comprises, when there is a plurality of first application objects:
displaying all of the plurality of first application objects on the display screen in a non-overlapping manner; or
selecting one of the plurality of first application objects based on a predetermined rule for displaying on the display screen.

7. The method for processing application object of claim 6, further comprising steps of, after said selecting one of the plurality of first application objects based on the predetermined rule for displaying on the display screen:
displaying a second indicator on the display screen, so as to prompt the user via the second indicator to perform a second predetermined operation in accordance with the second indicator so as to display another one of the plurality of first application objects on the display screen.

8. The method for processing application object of claim 3, wherein, when there is a plurality of first application objects, the first indicator and the plurality of first application objects are displayed on the screen in a one-to-one correspondence.

9. The method for processing application object of claim 1, wherein the first indicator comprises an operation directing line and the first operation is determined as the first predetermined operation when a track direction of the first operation follows a direction of the operation directing line.

10. An electronic device, comprising:
a display screen;
an instruction obtaining module configured to obtain a return instruction instructing to display an index interface on the display screen;
a first determining module configured to obtain a first determination result to determine whether a first application object exists, the first application object being currently in an opened state and associated with the index interface; and
a first display processing module configured to display the index interface and a first indicator on the display screen when the first determination result indicates that the first application object exists, so as to prompt a user via the first indicator to perform a first predetermined operation in accordance with the first indicator so as to display the first application object on the display screen.

11. The electronic device of claim 10, further comprising:
a detecting module configured to detect a first operation performed by the user on the index interface;
a second determining module configured to obtain a second determination result to determine whether the first operation is the first predetermined operation; and
a second display processing module configured to display the first application object on the display screen when the second determination result indicates that the first operation is the first predetermined operation.

12. The electronic device of claim 11, wherein one or more application objects associated with the index interface are preset and can be opened via the index interface, and the first determining module comprises:
a unit configured to obtain an application object currently in the opened state; and
a unit configured to determine whether there is an application object among the preset one or more application objects that is the same as the application object currently in the opened state, so as to obtain the first determination result,
wherein the first determination result indicates that the first application exists when there is an application object among the preset one or more application objects that is the same as the application object currently in the opened state, or indicates that the first application does not exists otherwise.

13. The electronic device of claim 11, wherein an interface attribute is preset for the index interface and the first determining module comprises:
a unit configured to obtain one or more application objects currently in the opened state;
a unit configured to extract an object attribute of each of the one or more application objects currently in the opened state; and
a unit configured to determine whether there is an application object among the one or more application objects currently in the opened state whose object attribute matches the interface attribute, so as to obtain the first determination result,
wherein the first determination result indicates that the first application exists when there is an application object among the one or more application objects currently in the opened state whose object attribute matches the interface attribute, or indicates that the first application does not exists otherwise.

14. The electronic device of claim 11, wherein an interface attribute is preset for the index interface and the electronic device further comprises:
an attribute determining module configured to determine, when each application object is opened, whether an object attribute of the opened application object matches the interface attribute; and
a recording module configured to record the opened application object in a set of application objects corresponding to the index interface when the object attribute of the opened application object matches the interface attribute, and
the first determining module comprises:
a unit configured to determine whether there is an application object in the set of application objects corresponding to the index interface to obtain the first determination result;
wherein the first determination result indicates that the first application exists when there is an application object in the set of application objects corresponding to the index interface, or indicates that the first application does not exists otherwise.

15. The electronic device of claim 12, wherein, when there is a plurality of first application objects, the displaying module is configured to display all of the plurality of first application objects on the display screen in a non-overlapping manner or select one of the plurality of first application objects based on a predetermined rule for displaying on the display screen.
